(19) United States
(12) Patent Application Publication
(10) Pub. No.: US 2021/0055734 A1
(43) Pub. Date: Feb. 25, 2021

(54) Methods Circuits Devices Assemblies Systems and Related Machine Executable Code for Providing and Operating an Active Sensor on a Host Vehicle

(71) Applicant: Hanoch Yokev, Kiryat Tivon (IL)

(72) Inventor: Hanoch Yokev, Kiryat Tivon (IL)

(21) Appl. No.: 16/946,765

(22) Filed: Jul. 6, 2020

Related U.S. Application Data
(60) Provisional application No. 62/870,707, filed on Jul. 4, 2019.

(51) Int. Cl. G05D 1/02; G01S 13/931; G01S 15/931; G01S 17/931; G01S 13/32; G01S 11/10; G05D 1/00; B60Q 9/00; G08G 1/16; H04B 1/16; H04B 1/04

(52) U.S. Cl. CPC G05D 1/0214; G01S 13/931; G01S 15/931; G01S 17/931; G01S 13/32; G01S 11/10; G05D 2201/0213; G05D 1/0088; B60Q 9/008; G08G 1/166; H04B 1/16; H04B 1/04; G05D 1/0223

(57) ABSTRACT

The present application relates to active sensors for vehicles to detect possible obstacles. The application teaches an obstacle detection system for a host vehicle which includes: (a) a vehicle navigation system comprising: (a) a vehicle trajectory detector, (b) a geolocator circuit, and (c) a clock output; (b) an energy emitting type sensor (“active sensor”) to transmit energy (Tx Signal) towards a direction in a field of view of said active sensor and to receives a Tx Signal reflection (Rx Signal) reflected off of objects present within the field of view, wherein the field of view is directed towards a front of the host vehicle and said active sensor is digitally configurable to operate according to at least two different operating regimes; and (c) an active sensor controller configured to select an operating regime for said digitally configurable active sensor based on a ruleset which factors one or more navigation system outputs provided by said vehicle navigation system.

### RELATED APPLICATIONS

The present utility application claims priority from U.S. Provisional Patent Application No. 62/870,707, filed on Jul. 4, 2019, the disclosure of which application is hereby incorporated by reference in its entirety.

### FIELD OF THE INVENTION

The present invention generally relates to the fields of wireless electromagnetic sensing. More specifically, the present invention relates to methods, circuits, devices, assemblies, systems and functionally associated machine executable code for providing and operating an active sensor on a host vehicle, optionally for obstacle detection and for use with an autonomous vehicle guidance system. Aspect of present invention relate to obstacle detection and avoidance systems supporting autonomous vehicular guidance and operation.

### BACKGROUND

A radar apparatus is a sensor of an active sensor type which transmits a radio-frequency (e.g., microwave or millimeter wave) signal (energy batch), also referred to as an interrogation signal or an illumination signal, from either a single or a set of antennas periodically into a space being scanned or interrogated. The transmissions are usually periodic according to transmission cycles (CPI—Coherent Processing Interval) and may be transmitted in a pattern across a space being interrogated or scanned for objects. A full radar is implemented by, in addition to transmission of an interrogation or illumination signal, receiving reflected portions of the transmitted signal, also referred to as echoes, which are reflected from surfaces of objects or targets within the interrogated space. The radar can also measure (a) distances to targets by calculating time of flight, (b) a target's radial speed using Doppler shift, and (c) a bearing between the radar and each of the targets. The reflections information received and collected from the area can be represented and referred to as a cloud of points or a point cloud.

Radars have numerous transportation related applications including in aviation and maritime safety systems. Radars are used for defense, airspace and even vehicular traffic management. Radar use of vehicular guidance, steering and obstacle detection is, however, very limited.

Although car radars were allocated, in Europe, the frequency bands of 24-26 GHz and 79-83 GHz, radar use on vehicles is still quite limited to mostly short-range detection of nearby surfaces. At present, radars on cars, mostly transmit a millimeter-wave signals (hereinafter referred to as “MMW radars”), are put in practical use as forward-looking, backward or side looking proximity sensors, mainly for detecting traffic obstructions. The Advanced Driver Assistance System (ADAS system) provided with most new cars, usually consist of combination of optical, acoustic and shortrange radars, mostly in the 24 GHz band. Although, ADAS sensors can be categorized as short, medium, and long range, longer range radar (i.e. 20 to 500 feet) for long range obstacle detection in connection with ADAS or autonomous vehicular guidance, steering and obstacle detection is currently limited.

There are six levels of driving automation defined in SAE International standard J3016_201609 six: (0) No Driving Automation; (1) Driver Assistance; (2) Partial Driving Automation; (3) Conditional Driving Automation; (4) High Driving Automation; (5) Full Driving Automation. In the tasks of the autonomous driving are summarized in few words: Autonomous driving is the highest level of automation for a vehicle, which means the vehicle can drive itself from a starting point to a destination with no human intervention. The problem can be divided into two separate tasks. The first task is focused on keeping the vehicle moving along a correct path. The second task is the capability to perceive and react to unpredictable dynamic obstacles, like other vehicles, pedestrians, and traffic signalization.

In order to achieve every level of autonomy above level 0, autonomous cars need to use a fusion of several sensors working together. Large numbers of sensors and sensor processing will be required in order to provide a sufficient level of situational awareness and driving safety. The processing system behind these sensors must “reproduce” the “reality” around the vehicle based on large numbers of diverse sensor measurements. The processing needs to generate an “Augmented Reality” for the guidance system of the vehicle in order for it to generate driving commands which keep the vehicle on an intended route with a sufficient level of driving safety. The situational awareness required for an autonomous car's control system, or ADAS chores, can be categorized as: (1) “Know the road”—Autonomous car should drive in the right side of the road (left in former GB colonies), distinguish between the paved road lanes and road shoulders, recognize sidewalks, able to navigate on dirt road, follow the road curves etc.; (2) Identify static obstacles, such as large stones, cracks, and dips on its route—Specific attention must be paid to bridges or sign road above the highway (elevation resolution); (3) Provide safety to other road users such as pedestrians, bicycles, pets etc.; (4) Sharing the road with other autonomous or men-driven cars; and (5) All whether and visibility conditions.

Autonomous driving support and safety systems in future vehicles will be comprised of a fusion of several interwoven technologies: (1) Optics, cross eye systems for very short-range alert; (2) Short range and medium range radars, detecting cars inside lanes and in front; (3) Back-up and self-parking ultrasonic or short-range radar systems; (4) All systems based on cameras, for identifying obstacles (people, bicycles, etc.) and road-sides signs; and (5) Long range sensor, providing alert in due time while considering the high-speed traffic. An example of a full-fledged integrated vehicular sensor solution, as part of an autonomous car, is presented in FIG. 1. The illustrated system is intended and configured to exploit advantageous features of each respective sensing technology in order to overcome limitation and disadvantages of other sensing technologies, so as to provide a complete mutually supportive and reinforcing sensor mesh for the host autonomous vehicle.

Various active sensor technologies such as Light Detection & Ranging (LIDAR), Millimeter Wave (MMW) Radars, Ultrasonic and smart optical systems compete on the same vehicle related market and at the same time complement each other. Each technology, however, has issues when large numbers of systems are working in proximity which will be the can more cars are smart car or autonomous. Therefore, there is a need for improved active sensors, active sensor controllers and active sensor systems which compensate for and mitigate the effects of possible interference between a number of active sensor systems operating from within vehicles passing near or by each.

### SUMMARY OF INVENTION

Embodiments of the present invention may include an obstacle detection system for a host vehicle. The obstacle detection system may include or be functionally associated with a vehicular navigation system and a multi-mode active sensor, which active sensor may include a controller which adjusts active sensor operation based at least partially on output from the vehicular navigation system. The vehicle navigation may include one or more of: (a) a vehicle trajectory detector or estimator, (b) a geolocator circuit (e.g. GPS), and (c) a digital clock or alternative time reference. The vehicular navigation system according to certain embodiments may also include a one or more digital maps of roads, streets, walkways and buildings.

An obstacle detection system according to embodiments may include an energy emitting type sensor (“active sensor”) to transmit energy (Tx Signal) towards a direction in a field of view of said active sensor and to receives a Tx Signal reflection (Rx Signal) reflected off of objects present within the field of view, wherein the field of view is directed towards a front of the host vehicle and said active sensor is digitally configurable to operate according to at least two different operating regimes. The active sensor may be of a sensor type selected from the group consisting of: (1) Radar, (2) Lidar and (3) Sonar.

An active sensor controller, integral or otherwise functionally associated with the active sensor, may be adapted, programmed or otherwise configure to select an operating regime for the digitally configurable active sensor. The controller may digitally regulate operation of the active sensor at least partially based on a ruleset which factors one or more navigation system outputs provided by an integral or otherwise functionally associated vehicle navigation system. The ruleset of said active sensor controller may factor one or more navigation system outputs selected from the group consisting of: (a) present time; (b) host vehicle location; and (c) host vehicle velocity/trajectory. According to embodiments of the present invention, (d) a unique identifier associated with the host vehicle, the active sensor, the navigation system and or the controller may also be factored when configuring the active sensor. For example, some combination of through (a) through (d) may be used in selecting a Tx Signal modulation scheme and or coding. According to Some embodiments, some combination of these factors may be used to select a set of frequencies and or waveforms (optionally orthogonal) for the Tx Signal chain to generate and for adjusting corresponding configurations on the Rx Signal receiver/decoder.

Since location, time and velocity are all dynamic factors while are vehicles is on a journey, the Tx Signal configuration, along with corresponding Rx chain configuration, of the active sensor may be continuously adjusted as the vehicle travels along its journey. Since, according to embodiments of the present invention, different vehicles and their respective active sensors will have different unique identifiers associated with them, even nearby vehicles traveling in the same direction at the same time and speed should generate differently coded (distinguishable) Tx Signals. The different, unique, signal coding may provide for interference mitigation between two or more vehicles traveling near or by each other. It may also provide for improved Rx Signal detection for each active sensor individually.

The active sensor controller may be adapted, programmed or configured to adjusts a characteristic of the Tx Signal generated by the active sensor based on one or more navigation system outputs. The adjustable characteristic of the Tx Signal may be selected from group consisting of: (1) transmission modulation or coding regime of the Tx Signal, (2) a transmission direction or scanning pattern of the Tx Signal, (3) transmission timing (“TDM”) of the Tx Signal, and (4) transmission polarization of the Tx Signal. The controller may regulate the Tx Signal by sending control signals to a Tx Signal source/transmitter circuit, which source circuit may include a signal generator, a signal amplifier, a signal modulator and or a transmission steering circuit which may include an array of Tx antennas. According to some embodiments, an instantaneous coding scheme of the Tx Signal may depend on a real-time of day output by the navigation system or by an alternative time source/reference. The instantaneous Tx coding may also factor in geolocation and velocity output of the navigation system. According to yet further embodiments a unique identifier assigned to or associated with the active sensor controller may be factored when selecting and or generating the Tx Signal. When a Tx Signal coding scheme of an active sensor is adjusted, Rx Signal processing may on the same active sensor may also be adjusted to a correspond.

An active sensor controller according to embodiments may also be adapted, programmed and/or configured to adjust operation of an Rx Signal receiver circuit of the active sensor, for example, to correspond to a current Tx Signal mode. The active sensor controller may adjust one or more operational parameters on an Rx chain of the active sensor, including: (a) direction of receptivity of an Rx beamformer, (b) gain of a low noise amplifier, (c) demodulation signal frequency and or pattern, and (d) signal filters.

An obstacle detection system according to some embodiments may further include an active sensor output processor, integral or otherwise functionally associated with the active sensor, adapted to process active sensor output signals from the active sensor corresponding to received Rx (Tx Signal reflections) Signals. The output processing may be at least partially based on a ruleset which factors one or more system outputs provided by said vehicle navigation system. The active sensor output may be at least partially processed and or interpreted based on information provided to the processor from an integral or otherwise functionally associated navigation system. The ruleset of that the active sensor output processor may factor one or more navigation system outputs selected from the group consisting of: (a) present time; (b) host vehicle location; and (c) host vehicle trajectory. The active senor output processor may perform functions such as point cloud estimation, object detection and collision estimation/detection. Processing of active sensor output signals may also include detection of an alert condition, generating signals to maneuver the host vehicle and/or to stop the host vehicle.

According to embodiments where the vehicle navigation system includes or is functionally associated with a digital roadmap and the active sensor output processing may perform detection and classification of obstacles around the host vehicle. The output processor may also estimate a position and trajectory of the host vehicle within a reference frame defined by the road map. Active sensor output processing may further include estimating a position, velocity vector and trajectory of the obstacle within the reference frame defined by the road map. The digital roadmap may be used: (a) as a constraint when predicting a future location of the host vehicle; (b) a constraint when predicting a future location of the detected obstacle; and (c) to identify detected as buildings and other fixed structures near a path of a host vehicle.

The output processor may estimate a relevance (e.g. possibility of collision) of a detected obstacle by factoring a location and trajectory of the host vehicle, a location and trajectory of the detected obstacle and a predicted future location of the host vehicle and/or detected obstacle on the digital roadmap. Predicted concurrence of the vehicle and the detected obstacle at the same point of the digital map at the same may result in a collision prediction condition. The active sensor output processor may further be adapted to generate an alert notification if the estimated trajectory of the detected obstacle and the trajectory of the host vehicle intersect.

Some embodiments may include an active sensor which is adapted to transmit and receive electromagnetic signals within each of two or more frequency bands and said controller may be adapted to select in which band the active sensor is operating based on information provided by the navigation system. The active sensor may be adapted to operate the active sensor within different frequency bands at different Tx Signal angles relative to a host vehicle. For example, the controller may be configured to cause the active sensor to operate in a first frequency band at angles towards the left side of a host vehicle and to operate in a second frequency band at angles towards the right side of a host vehicle. More granular and more complex frequency selection schemes, responsive to navigation system output, are possible and anticipated as embodiments of the present invention.

According to some embodiment, the active sensor may be a multi-modulation radar and said active sensor controller may cause the radar to switch between two or more operating standards selected from the group consisting of: (1) Frequency Modulated Constant Wave (FMCW), (2) Orthogonal Frequency Division Multiplexing (OFDM), and (3) Pulse Doppler, and Step Frequency or Frequency Hopping (SF/FH). Within each of the standards, different frequency bands and coding schemes may be used.

The active sensor output processor may be further adapted to distinguish between a received (Rx) signal which originated as a Transmission (Tx) from its respective active sensor and a received signal which originated from an interfering signal source, such as for example, another active sensor associated with another vehicle. The active sensor output processor or active sensor controller of a given active sensor may be configured to mitigate interference to the operation of their respective active sensor by signals from external signal sources. Mitigation may include operation mode and/or frequency band selection. It may also include implementation of specific types of signal filters.

The radar may use one, two or a larger set of frequency bands for the Tx Signal, and corresponding Rx chain. Band selection and directions can be fixed or modulated. Various band selection schemes are possible an anticipated as embodiments of this invention. The term frequency band according to the present application many mean a range of continues frequencies, a set of orthogonal frequencies, or a combination of the two. According to some embodiments, a controller may cause the radar to swap or otherwise alternate frequency composition and or direction of first and second bands of the Tx & Rx Signals. For example, the first band may be used to operate towards the right side (e.g. first Tx Lobe) of a host vehicle and the second band may be used to operate towards the left side (e.g. second Tx Lobe) of a host vehicle. The controller may instruct, or configure the radar to adjust frequencies and/or modulation/coding schemes of each of the first and second bands of operation depending upon one or more factors selected from: (1) vehicle location, (2) vehicle direction, (3) time of day, (4) a unique identifier, and (5) digital maps or digital map indicators. Information such as time or day may, location, velocity and or anything else known to the active sensor may be used as part of encoding scheme for a Tx Signal in order to differentiate its received reflection from signals generate by other sources. According to some embodiments, the active sensor may use only one concurrent band, while according to other embodiments, there may be many concurrently used bands. There may be one Tx lobe or many lobes. The bands within the context of their spatial/angular distribution (i.e. Tx lobes) may likewise be adjusted according to some or all of the above-mentioned factors. Rx lobe adjustments may be made to match corresponding Tx lobe configurations.

Embodiments of the present invention include methods, circuits, devices, systems and functionally associated machine executable instructions for vehicular obstacle detection and avoidance. The present invention includes methods, circuits, devices, assemblies, systems and functionally associated machine executable code for operating a vehicle mounted, or otherwise functionally associated, Radio Detection and Ranging (radar) device or system. The present invention includes methods, circuits, devices, assemblies, systems and functionally associated machine executable code for processing vehicle mounted radar device output. Embodiments of the present invention include methods, circuits, devices, systems and functionally associated machine executable instructions for providing data to, and thereby facilitating operation of, computer guided or controlled vehicular navigation and steering. Embodiments of the present invention include methods, circuits, devices, systems and functionally associated machine executable instructions for facilitating autonomous vehicle guidance, steering, operation and collision avoidance systems.

According to some embodiments of the present invention, a Vehicular Radar (VR) may be integrated or otherwise functionally associated with a host vehicle and may be used to detect, map and track obstacles such as road dividers, poles, buildings and other vehicles on and near the host vehicle's route. A VR according to embodiments of the present invention may include or be functionally associated with a radio signal transmission (Tx) chain, a radio echo signal receiver (Rx) chain, and radar controller circuitry including targeting, modulation and demodulation selection logic. The Tx chain may include an electronically adjustable Tx signal source, and the Rx chain may include a corresponding electronically adjustable signal receiver and or demodulator whose mode of operation may be adjusted to track, match and or correspond to that of the Tx signal source. Accordingly, the VR's radio frequency related parameters may be adjusted to meet one or more operational parameters, constraints or challenges. For example, mitigating or eliminating cross interference between radars on different vehicles may be achieved by selection of Tx Signal parameters such as frequency and or pseudorandom code according to geolocation, direction (NW or SE) and time of day obtained from the geo navigation system on each the host vehicles. Other encoding factors may include unique identifier assigned to or otherwise associated with each radar.

The Tx chain may terminate at an electronically steerable Tx beamforming network connected to an array of Tx antennas, wherein the Tx beamforming network working in concert with the Tx antenna array may be configured to focus and direct a modulated Tx signal in a selected direction, optionally according to a radar Tx scanning pattern. The Rx chain may connect to an electronically steerable Rx beamforming network connected to an array of Rx antennas, wherein the Rx beamforming network working in concert with the Rx antenna array may be configured to focus and receive an Rx signal from a selected direction, optionally a direction substantially corresponding the Tx beamformer's instantaneous (e.g. currently selected) transmission direction.

Radar controller circuitry according to embodiments of the present invention may include application specific programming, logic and signal processing capabilities to facilitate, adjust and enhance operation of a radar in various operational contexts, including vehicular contexts. Radar signal processing to convert detected signal echoes/reflections into point clouds and then further into object feature detections may be embedded into the radar controller or in functionally associated signal processors. Radar generated information may provide situational awareness to a host vehicle guidance system or controller which controls the host vehicle upon the VR is operating. Radar generated information may be used by the guidance system or controller to change the host vehicle's speed, breaking and or steering.

Radar controller circuitry according to embodiments may include functional blocks to monitor and respond to possible interference from other signal generating sources in proximity of a host vehicle. Radar controller circuitry according to further embodiments may include circuits to monitor and process received radar echo signals so as to detect objects in proximity of the VR and to assess associated collision risk—that is, to assess whether the detected objects are obstacles in the path of the host vehicle or are on a collision course towards the host vehicle. Accordingly, a VR according to embodiments of the present invention may also be referred to as an obstacle or collision detection device. When a VR according to embodiments provides obstacle information to a host vehicle's autonomous steering system, the VR may be referred to as an obstacle avoidance device. (See FIG. 2B)

A VR according to embodiments of the present invention may include or be functionally associated with Interference Mitigation Circuitry (IMC) configured to facilitate coexistence and substantially unimpeded operation of two or more VR's in proximity with one another. The IMC may also operate to mitigate interference with normal VR operation from other radars or from other non-radar radio interference sources. A VR according to further embodiments of the present invention may include or be functionally associated with an Obstacle Relevance Evaluation (ORE) module which can, based on live sensor data and on optionally on digital map information, evaluate whether an obstacle detected by the VR to be in some proximity with the host vehicle may pose a collision risk to the host vehicle. Both the IMC and the ORE may be integral, or otherwise functionally associated, with the VR's controller circuitry (FIGS. 2A and 2B).

An Obstacle Relevance Evaluation (ORE) module according to embodiments of the present invention may process and interpret detected radio wave reflections or echoes, optionally in the form of detected point clouds, generated by a VR mounted on a host vehicle within a context of the host vehicle's location, orientation and trajectory. Accordingly, an ORE may either include or be functionally associated with a vehicle navigation system which includes: (a) a vehicle trajectory detector/estimator; (b) a geolocator circuit (e.g. GPS); and (c) a digital road map. The navigation system may provide the ORE with the host vehicle contextual information such that the ORE can process output signals from the VR at least partially based on vehicle trajectory, location and road map information.

When processing VR output, the ORE may, upon the VR detecting an object in some proximity of a host vehicle, estimate a position or location of the detected object within a real-world reference frame, such as that defined or otherwise established by the digital map. More specifically, by comparing a host vehicle's instantaneous location, direction and trajectory against a relative location of a VR detected object, the ORE may place or map the object detected and ranged by the VR relative to the host vehicle (e.g. 13 deg to the left of and 24 meters in front of the vehicle) into a real world location, such as for example estimate the latitude and longitude of the detected and ranged object. By comparing the actual physical location of a VR detected object with digital map information including locations of roads, intersections, streets, dividers, builds, landmarks, etc., an ORE according to embodiments of the present invention may determine placement of the detected object within the real world context (i.e. road, barrier, street, etc.) and thereby classify the detected object. For example, the ORE may classify the detected object as another vehicle if the object is estimated to be in a location designated as a road by the digital map, or the ORE may classify the detected object as a structure if the object is estimated to be in a location designated as a non-roadway by the digital map.

According to further embodiment, in addition to receiving detection and range information regarding an object detected by a VR, the ORE may also receive from the VR velocity information about the detected object, an estimate of the detected object's direction and speed. A detected object's velocity may also assist in the object's classification by the ORE. Fast-moving objects located on roadways may be classified as vehicles. Trajectories of fast-moving objects located and moving on roadways may be estimated or predicted by constraining the detected movement vector of the object within the boundaries (e.g. roads, street curbs, dividers, intersections, etc.) designated by the digital map. By calculating future possible positions of detected moving objects, based on estimated trajectories, route possibilities of detected objects may be predicted.

By comparing a predicted route of a VR detected object against a route of a host vehicle, an ORE according to embodiments of the present invention may estimate a probability of collision between the host vehicle and the VR detected object. If by comparing predicted routes the ORE identifies that points on the host vehicle and the detected object's predicted routes are crossing or intersecting, overlapping or converging to a common area nearer than some limit, the ORE may generate an alert notification to the host vehicle and or its occupants. If, on the other hand, the ORE determines that the predicated routes of the detected vehicle and the host device are diverging and that the detected object poses no risk to the host vehicle, the ORE may ignore, discard or even suppress VR generated object detection data associated with the object moving away from the host vehicle.

An IMC according to embodiments of the present invention, integral or functionally associated with a given VR's controller circuitry, may utilize frequency domain, time-domain, space domain or angular coding schemes to mitigate interference from radio signals generated by sources other than the given VR. An IMC according to embodiments of the present invention may utilize frequency domain coding, time-domain coding, space-domain coding, angular coding and or any combination of these coding schemes to mitigate possible interference between multiple VR's operating in proximity with one another. IMC may factor location, velocity, real time of day, a unique identifier as an input for generating orthogonal, non-interfering, waveforms for the ORE. IMC's associated with different VR's may indirectly coordinate mitigation interference activity by following mitigation rules or protocols associated with their respective unique identification, locations, directions and real time of day. IMC's associated with different VR's may directly coordinate mitigation interference activity by applying a specific protocol or rule when detecting the other VR's location and or mode of operation.

An IMC according to embodiments of the present invention may perform interference mitigation by regulating its respective VR's Tx signal modulation and or Tx signal transmission pattern. The IMC may also regulate the VR's corresponding Rx echo signal receiver's configuration and operation, based on sampling of the VR's electromagnetic environment. The IMC may detect and classify actual recurring interference of a specific type from a specific location and may in response to the interference adjust the VR's operation to reduce its sensitivity to interference of the classified interference type.

An IMC according to further embodiments of the present invention may regulate operation of a respective VR's signal chains, Tx and Rx, and signal targeting in accordance with a ruleset which factors dynamic parameters of the VR's host vehicle, such as for example the host vehicle's location, orientation, direction, velocity, identification, etc. According to yet further embodiments, the IMC may factor both detected electromagnetic interference and the host vehicle's dynamic parameters when adjusting operational configuration of the VR to mitigate VR performance degradation from current and future possible interfering radio signal sources.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a top view illustration of an exemplary vehicle including a proposed mesh of sensors of deferring sensor types and working together as an integrated sensor solution to provide advanced driver assistance (“ADAS”) functionality and optionally to provide input to an autonomous vehicular control/navigation control system;

FIG. 1B is a photograph of an actual autonomous vehicle being operated in Berlin and utilizing a variety of shortrange, midrange and long-range sensors as input to the autonomous vehicle drive control system;

FIG. 1C is a side illustration of vehicle with active forward scanning sensors, each with a different coverage area at least partially defined as a function of range from the vehicle;

FIG. 2A is a functional block diagram of an exemplary vehicular radar with obstacle detection system according to advanced driver assisted embodiments of the present invention;

FIG. 2B is a functional block diagram of an exemplary vehicular radar with obstacle detection system according to autonomous vehicle embodiments of the present invention;

FIGS. 3A & 3B are exemplary antenna element array configurations, for Tx and Rx chains respectively, in accordance with embodiments of the present invention;

FIG. 3C shows a generic radar signal parameter detection matrix used to estimate detected object characteristics, such as location, velocity and spatial direction;

FIGS. 4A to 4C relate to FMCW radars usable in conjunction with embodiments of the present invention, wherein: (a) FIG. 4B are frequency domain and amplitude domain signal graphs illustrating FMCW radar transmission (Tx) waveforms; (b) FIG. 4C is a frequency domain signal graph illustrating range and doppler shift indicators within a return (Rx) FMCW radar signal; and (c) FIG. 4C is a functional block diagram of an exemplary FMCW radar usable in accordance with embodiments of the present invention;

FIGS. 5A to 5C relate to OFDM radars usable in conjunction with embodiments of the present invention, wherein: (a) FIG. 5A is a functional block diagram of an exemplary OFDM radar usable in accordance with embodiments of the present invention; (b) FIG. 5B is a frequency domain signal graph illustrating the waveform of an exemplary Tx OFDM packet; and (c) FIG. 5C is a spectrogram illustrating an exemplary OFDM radar reflection from targets within an inspection zone of an OFDM radar in accordance with embodiments of the present invention;

FIGS. 6A and 6B relate to Pulse Doppler Radar usable in conjunction with embodiments of the present invention, wherein: (a) FIG. 6A is a signal graph illustrating the stepped frequency waveform of this radar type's Tx signal; and (b) FIG. 6B is a spectrogram illustrating an exemplary Rx radar reflection from two targets within an inspection zone of the radar which is illuminated by 144 transmitted Tx pulses in accordance with embodiments of the present invention;

FIGS. 7A and 7B relate to an exemplary automotive navigation system in accordance with embodiments of the present invention, wherein: (a) FIG. 7A shows a functional block diagram of a vehicular navigation system including a geolocator; and (b) FIG. 7B is an illustration depicting how a navigation system according to embodiments of the present invention estimates a host car's future point location based on road information within a stored map rather than a straight trajectory from a current point based on a current velocity vector;

FIG. 7C is a functional block diagram of an autonomous driving system receiving multifactor input including active sensor outputs, digital maps and location/velocity information according to embodiments of the present invention;

FIGS. 8A & 8B illustrate an exemplary FMCW radar and the (cross) interference which the radar may experience from signals originating from of FMCW radars. FIG. 8A is a simplified block diagram while FIG. 8B includes signal graphs illustrating the aforementioned interference;

FIGS. 9A & 9B are signal graphs illustrating issues related with interference in pulsed radar systems;

FIG. 10 relates to a method of spatial direction processing associated with ranging and doppler-shift measurement associated with an object being detected in accordance with embodiments of the present invention;

FIG. 11A to 11C illustrate an exemplary radar chip (FIG. 11A), and exemplary spatially encoded BPM-MIMO output waveform of the chip (FIG. 11B), and antenna arrays (Tx and Rx) corresponding to the chip and its Tx & Rx signal paths.

FIG. 12. Illustrates how circular polarization can be used to obtain signal orthogonality/isolation between a transmission from a transmitted antenna in a direction of a receiver antenna facing the transmitting antenna; and

FIGS. 13A and 13B illustrate two separate computational methods of mitigating the impact of signal interference from nearby interference sources, including by using a Kalman filter to eliminate a “radar ghost”.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE FIGURES

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), any composition and/or architecture of semiconductor based Non-Volatile Memory (NVM), any composition and/or architecture of biologically based Non-Volatile Memory (NVM), a rigid magnetic disk, and an optical disk. Some demonstrative examples of optical disks include compact disk-read only memory (CD-ROM), compact disk-read/write (CD-RW), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other functionally suitable components may be used.

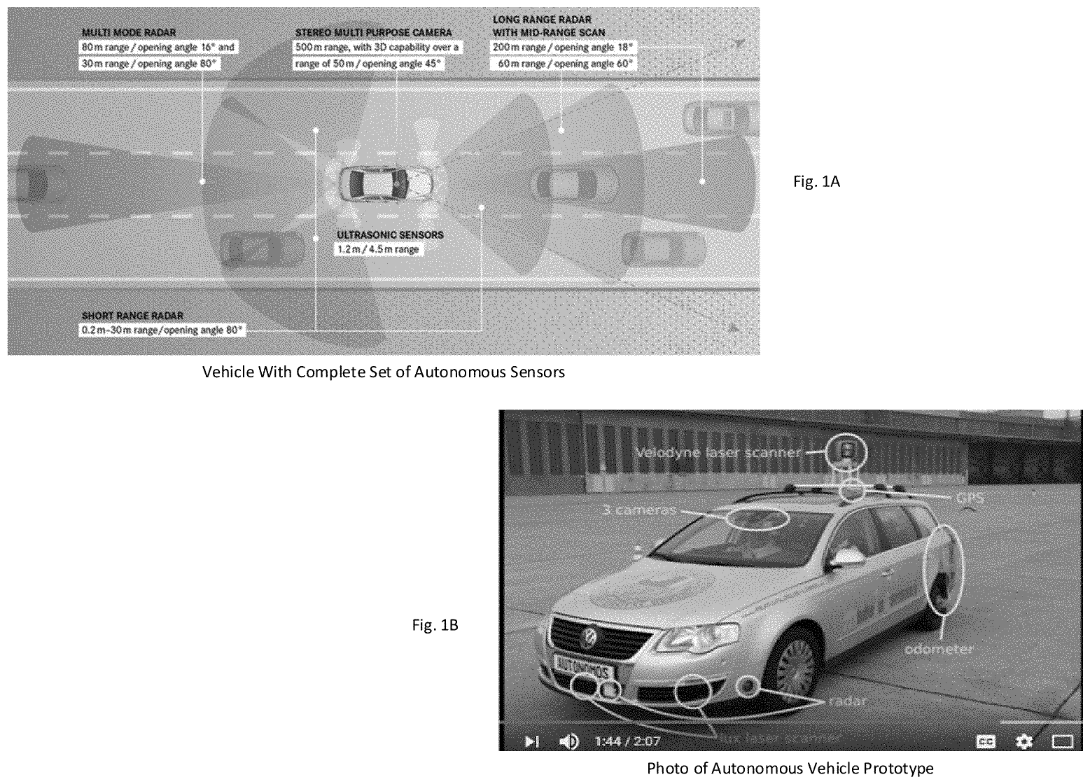

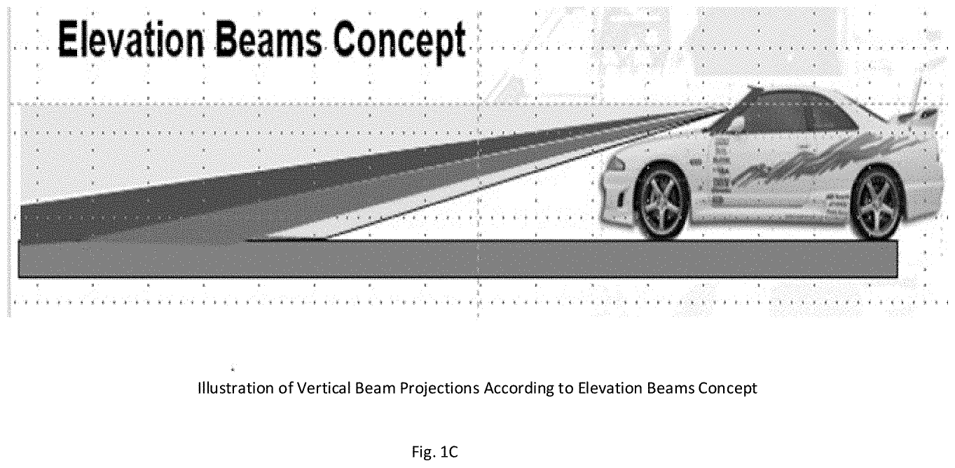

Turning now to FIG. 1A, there is shown a top view illustration of an exemplary vehicle including a proposed mesh of sensors of deferring sensor types and working together as an integrated sensor solution to provide advanced driver assistance (“ADAS”) functionality and optionally to provide input to an autonomous vehicular control/navigation control system. While FIG. 1B is a photograph of an actual autonomous vehicle being operated in Berlin and utilizing a variety of shortrange, midrange and long-range sensors as input to the autonomous vehicle drive control system. FIG. 1C is a side illustration of a vehicle with active forward scanning sensors, each with a different coverage area at least partially defined as a function of range from the vehicle and possibly direction. Details relating to the various, short, mid and long-range sensors reference and illustrated in these figures can be found in the background section.

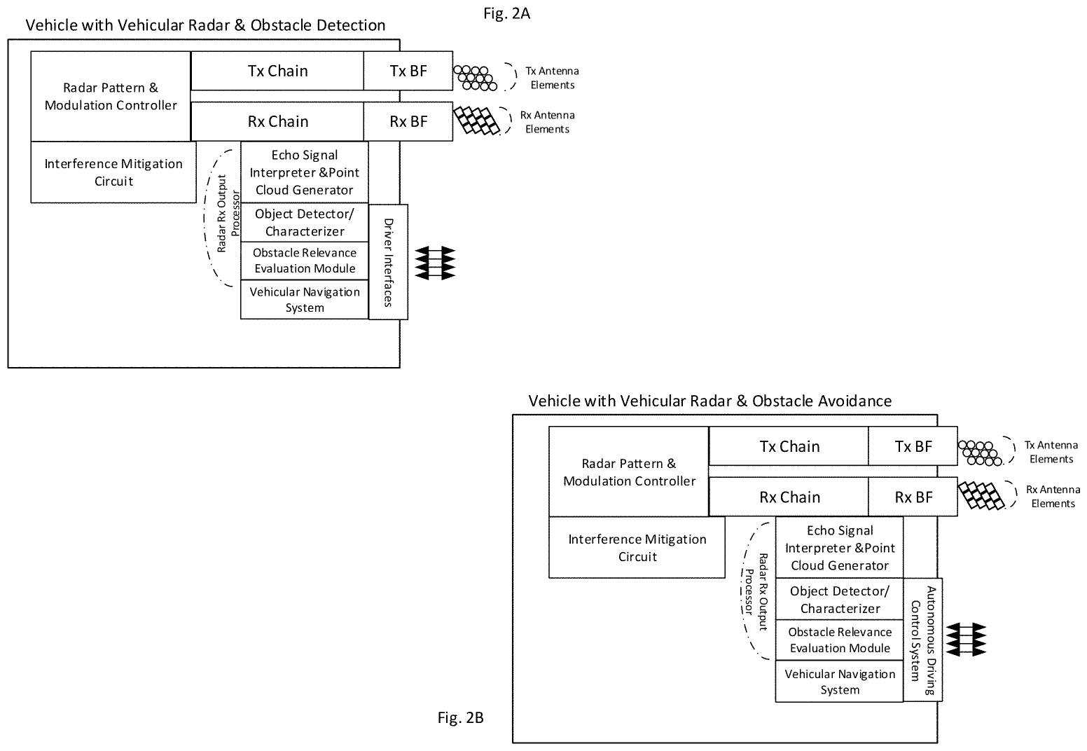

Turning now to FIG. 2A, there is a functional block diagram of an exemplary vehicular radar with obstacle detection system according to advanced driver assisted embodiments of the present invention. FIG. 2B is a functional block diagram of an exemplary vehicular radar with obstacle detection system according to autonomous vehicle embodiments of the present invention. Both embodiments include Tx Signal and Rx Signal chains, including optional MIMO and/or Beamforming networks with associated antenna arrays. Both Figs include a controller, a navigation system and a Rx output processor, all of which operate in accordance with the various embodiments described herein. The embodiments in FIGS. 2A and 2B differ only on the type of interface they show in connection with their respective host vehicles. The embodiment of FIG. 2A sends notifications to a driver while the embodiment of FIG. 2B interacts with a Host Vehicles autonomous controller/guidance.

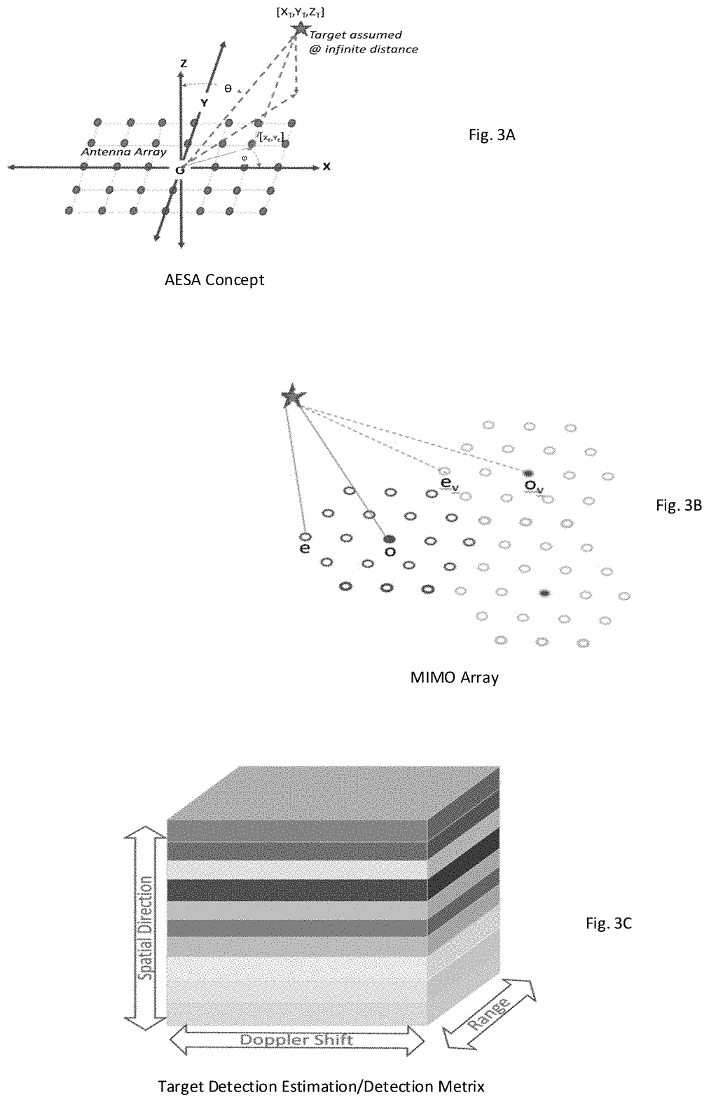

FIGS. 3A & 3B are exemplary antenna element array configurations, for Tx and Rx chains respectively, in accordance with embodiments of the present invention with target direction estimation. With regard to the AESA antenna of FIG. 3A, it is usable for target direction estimation. Direction is estimated by combination of AESA¹ antenna. The AESA antenna consists of plurality of elements, usually organized in rows and columns. The antenna operation equals the time delay of waves coming from specific direction, which results in summing up the input of output of those elements. AESA, consisting of N elements, has maximal gain of N times the gain of each element. AESA beam width or direction resolution², is defined by

$${θ}_{beamwidth} = \frac{k \cdot λ}{D} ( redians ) ≅ k \frac{57}{D \text{/} λ} ( degrees ) ,$$

where 0.5≤k≤1, D is the antenna length (in the same axis as θ) and λ is the wavelength. The distance between elements is

$$\frac{1}{1 + sin γ} ( k ) ,$$

where γ the boresight scanning width is. (In our case 30°, which produces k=0.67). ¹ AESA—active electronically scanned array (AESA), is a type of phased array antenna,² Resolution in here is defined by the required distance between two reflecting objects for distinction of both.

AESA is a MISO³ antenna. In MISO systems, the spatial location of the reception beams tilting is agnostic to the transmitter location. ³ MISO—many in single out.

FIG. 3B shows a MIMO⁴ technology array where radar's based on MIMO systems use several transmitters and the target location is estimated for each transmitter separately. The result is significant reduction of the number of antenna elements. Full AESA with M×N elements beam width is achievable with MIMO array of M+N elements, according to embodiments of the present invention.

Note that the symmetry in wave equations in wave directions allows swapping of transmitters and receivers.
MIMO concept is shown in FIG. 1—MIMO array example. The inner circles represent transmitting elements. There are 19 transmitting elements and 3 receiving elements
O—Origin of transmission array. Contains Xmtr & Rcvr.
Oᵥ—position of Receiver at the center of virtual array [Xₒᵥ, Yₒᵥ]
e—position of a Tx element, at [Xₑ, Yₑ]
eᵥ—virtual position of a Rx element, at [Xₑᵥ, Yₑᵥ] relative to Oᵥ
   The position of e relative to origin equals to the position of eᵥ relative to Oᵥ.
   Distance is translated to phase by multiplying by k (=2π/λ)
rₑ: difference of target's distance of e and origin
rₑᵥ: difference of target's distance of eᵥ and origin
rₒᵥ: difference of target's distance of Oᵥ and origin
Symmetry: note that [Xₑ, Yₑ]=[Xₑᵥ, Yₑᵥ], assuming target at FIG. 1—MIMO ARRAY EXAMPLE infinity
Position of virtual element in the original axis: eᵥ [Xₑ−Xₒᵥ, Xₑ−Yₒᵥ]
Difference of distance of target at (φ,θ) of virtual element eᵥ and orgin: (Xₑ−Xₒᵥ)cos φ cos θ+(Yₑ−Yₒᵥ)sin φ cos θ=rₑᵥ=rₑ−rₒᵥ
The difference of distance of target at (φ, θ) of virtual origin oᵥ and transmission element e. The virtual elements phase around oᵥ can be obtained by measuring the phase of each of the transmitters
Conclusion: the phase difference of eᵥ and oᵥ is the same to phase € and phase (o). 3 receivers and 19 transmitters produce same resolution as AESA with 57 elements (19×3) ⁴ MIMO—many in many out, used in radar and communication. In radar, it is used for reduction of AESA elements

There is an assumption that the receivers can identify and separate the multiple transmissions. There are 3 methods of separation:
1. Time domain: sequential transmission (losing energy).
2. Frequency domain (reduce available spectrum)
3. Phase domain, using Walsh-Hadamard sequences or other binary orthogonal sequences.

In long range radar, the possible series length is much larger than the number of required orthogonal transmitters. For instance: PRI 5 of 30 microseconds within CPI of 50 milliseconds generates over 1600 series for 12 transmitters, there over 130 orthogonal codes combination, that could serve other radars. ⁵ PRI—pulse repetition interval

The processing of the coded signals may be performed using butterfly machine of ones and zeros. Most used sequence is Walsh-Hadamard series (WHS) and transform. (See FIG. 3C). The method is used in Wi-Fi 6 MIMO systems.

The WHS have the following features:
Its elements are merely ±1.
The transform matrix is based on “butterflies”, which allows decoding several inputs simultaneously.
Coding and decoding matrices are equal.

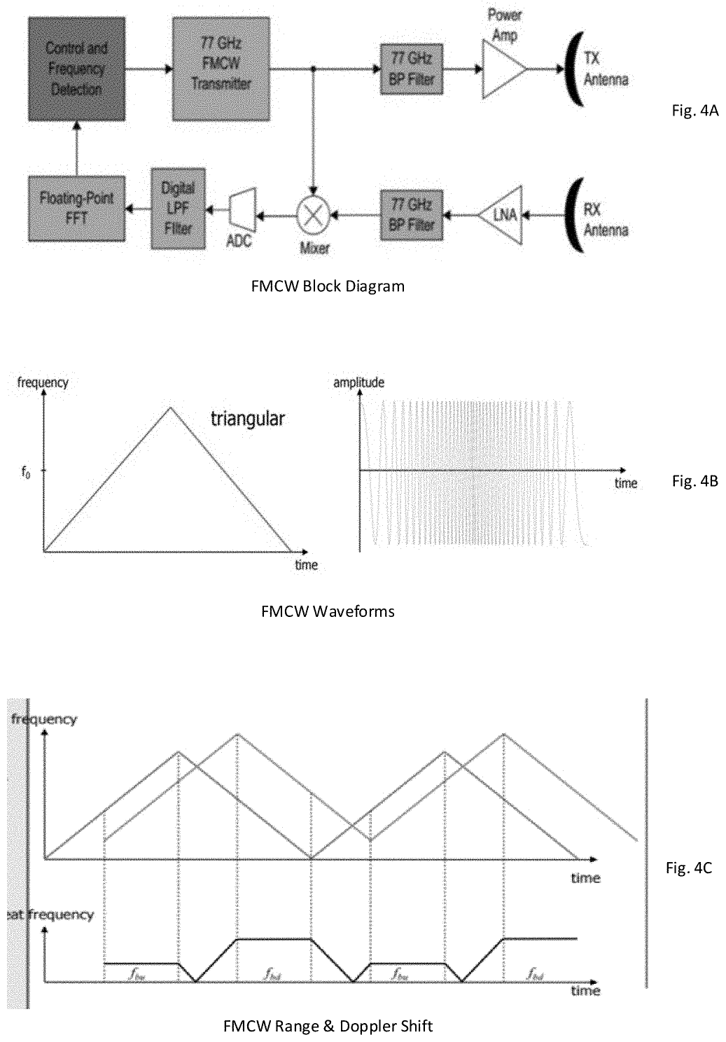

FIGS. 4A to 4C relate to FMCW radars usable in conjunction with embodiments of the present invention, wherein: (a) FIG. 4B are frequency domain and amplitude domain signal graphs illustrating FMCW radar transmission (Tx) waveforms; (b) FIG. 4C is a frequency domain signal graph illustrating range and doppler shift indicators within a return (Rx) FMCW radar signal; and (c) FIG. 4A is a functional block diagram of an exemplary FMCW radar usable in accordance with embodiments of the present invention.

FMCW radars as shown in FIG. 4A are the most common as long-range sensors. The principal of the radars is transmitting a continuous carrier modulated by a periodic function such as a sinusoid or saw tooth wave to provide range data OFDM Radar (FIG. 4B). Range is estimated from the difference of the echo frequency and the local oscillator frequency. (Beat frequency). The range and the radial frequency are derived from the beat frequency, as shown in the following:

$$r = \frac{{cT}_{s}}{4 {B}_{sweep}} ( {f}_{up} + {f}_{dn} )$$

$$\dot{r} = \frac{λ}{4} ( {f}_{up} - {f}_{dn} )$$

The structure of OFDM radar according to embodiments of the present invention may include multiple receiving antennas that are used for horizontal narrow beams generation, and AESA antenna for transmission elevated beams generation. The FMCW radars are coherent (phase continuous), hence additional FFT is performed on the detected ranges for obtaining range derivative, i.e. Doppler shift. Advantages of FMCW radars include simplicity and low cost.

Regardless of the radars type, the processing of the target's direction starts from the range/Doppler unambiguous plan. Each of the reception antennas, builds several plans, according to the number of transmitters. Separation of the transmissions is done by multiplying with inverse Hadamard matrix. Let us assume that the transmission AESA scans the space. Obviously, its beam is much wider. We sum up the vectors at specific direction which generates a narrow beam, thus improving the SNR and hence the radar detection range. The “fine” beams, within the “gross” transmission beam are generated simultaneously using FFT. The process is depicted in FIG. 4C. The layers represent the range Doppler unambiguous plan of each combination of transmitter/receiver. There are N_{receivers}×Mₜᵣₐₙₛₘᵢₜₜₑᵣₛ, Therefore N×M unambiguous planes. The direction is calculated by summing up the values with proper phase shifting according to the required spatial direction. If the antennas elements are ordered properly, the range distance (phase) between adjacent elements will be fixed, which allows summation of several beams using FFT.

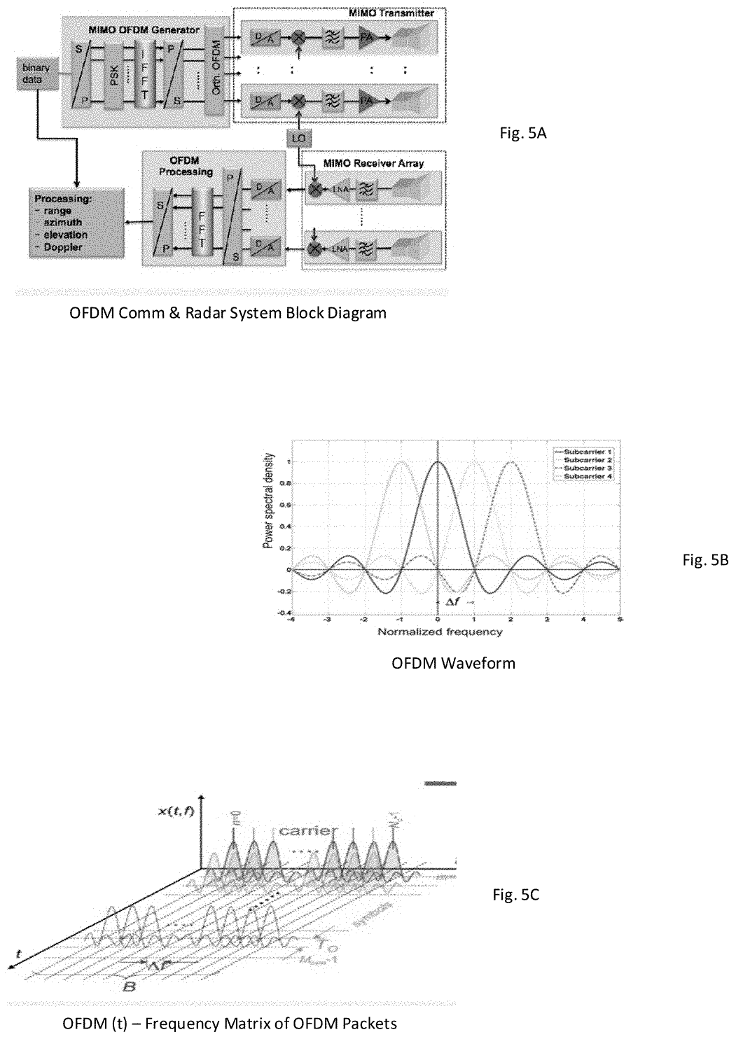

Turning now to FIGS. 5A to 5C, they relate to OFDM radars usable in conjunction with embodiments of the present invention, wherein: (a) FIG. 5A is a functional block diagram of an exemplary OFDM radar usable in accordance with embodiments of the present invention; (b) FIG. 5B is a frequency domain signal graph illustrating the waveform of an exemplary Tx OFDM packet; and (c) FIG. 5C is a spectrogram illustrating an exemplary OFDM radar reflection from targets within an inspection zone of an OFDM radar in accordance with embodiments of the present invention.

OFDM is another option for wireless communication and long-range radar for autonomous car operation in accordance with embodiments of the present invention. It has inherent advantage of assimilation of two technologies that assist each other. The waveform contains plurality of orthogonal frequencies called subcarriers. In regular Wi-Fi protocol, the distance between the subcarriers is exactly an even fraction of the packet length. The energy is sent in pulses, called packets that are few microseconds long. The block diagram of the radar follows regular OFDM communication system, with multiple antennas. The digital symbols are divided between the subcarriers. The subcarriers vector is converted into a serial vector using IFFT. In reception, the inverse process is applied. The subcarriers are converted into a vector using FFT.

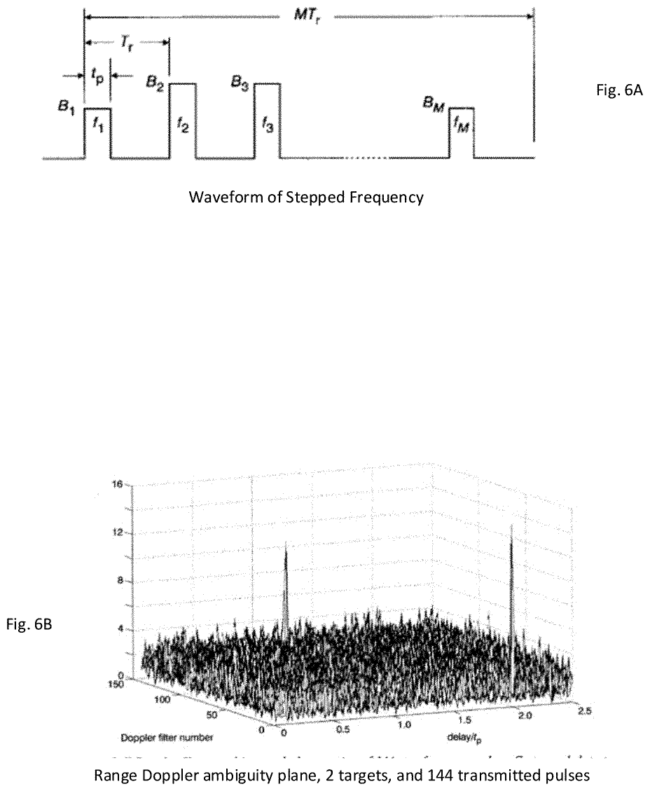

FIGS. 6A and 6B relate to Pulse Doppler Radar usable in conjunction with embodiments of the present invention, wherein: (a) FIG. 6A is a signal graph illustrating the stepped frequency waveform of this radar type's Tx signal; and (b) FIG. 6B is a spectrogram illustrating an exemplary Rx radar reflection from two targets within an inspection zone of the radar which is illuminated by 144 transmitted Tx pulses in accordance with embodiments of the present invention.

Pulse Doppler radars are most commonly used for alerts of aerial, naval and ground based targets. Different from FMCW and OFDM radars, the transmission and reception do not overlap. The advantage is common reception and transmission antennas. The disadvantage is the inability to receive during transmission time—short “blind” range. A required minimal range of 15 m (50 nanoseconds) imposes range resolution, which is insufficient. The proposed solution according to embodiments of the present invention is a method of frequency hopping. Step-frequency with stretch processing is especially attractive in radar sensors for short ranges like automotive radar, for two reasons:
i. The simplicity of the processor, hence its low cost
ii. Since the typical delay could be shorter than pulse duration, and since the receiver is turned off during transmission, not all the reflected signal is available to the receiver.”

Additionally, turning off the receiver during transmissions allows using some antennas for MIMO. The waveform is described in FIG. 6A. The range resolution is achieved by the spread of the waveform, from the lowest to the highest frequency.

$$δ r \approx \frac{c}{2 BW} = \frac{c}{2 ( {F}_{high} - {F}_{low} )}$$

The echoes in each frequency are reordered after the reception, from the lowest to the highest frequency. The result is similar to “sampled” FMCW, with much better side lobes performance. The result is low side lobe in the ambiguity plane (range-Doppler), as shown in FIG. 6B. The frequency stepping is usually done with DDS⁶. Another feature is the separation between transmitters: shuffling the starting point of the Costas sequence between the transmitters, separate the echoes among them. ⁶ DDS—Direct Digital Synthesizer

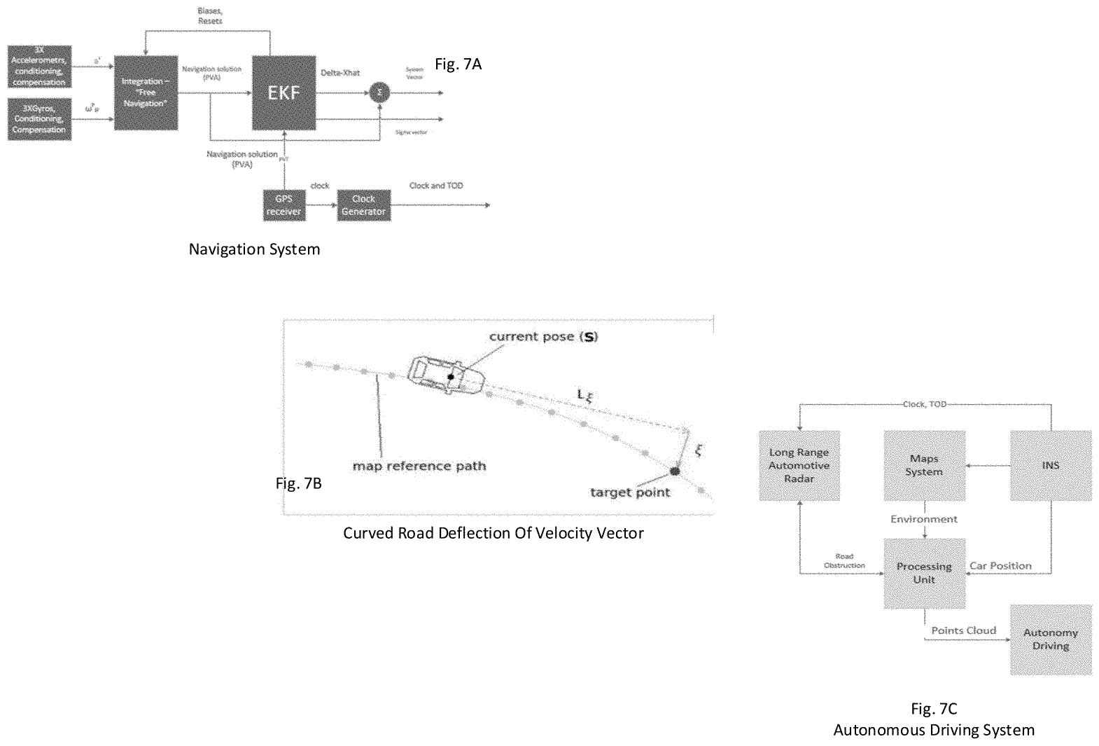

FIGS. 7A and 7B relate to an exemplary automotive navigation system in accordance with embodiments of the present invention, wherein: (a) FIG. 7A shows a functional block diagram of a vehicular navigation system including a geolocator; and (b) FIG. 7B is an illustration depicting how a navigation system according to embodiments of the present invention estimates a host car's future point location based on road information within a stored map rather than a straight trajectory from a current point based on a current velocity vector.

FIG. 7C is a functional block diagram of an autonomous driving system receiving multifactor input including active sensor outputs, digital maps and location/velocity information according to embodiments of the present invention.

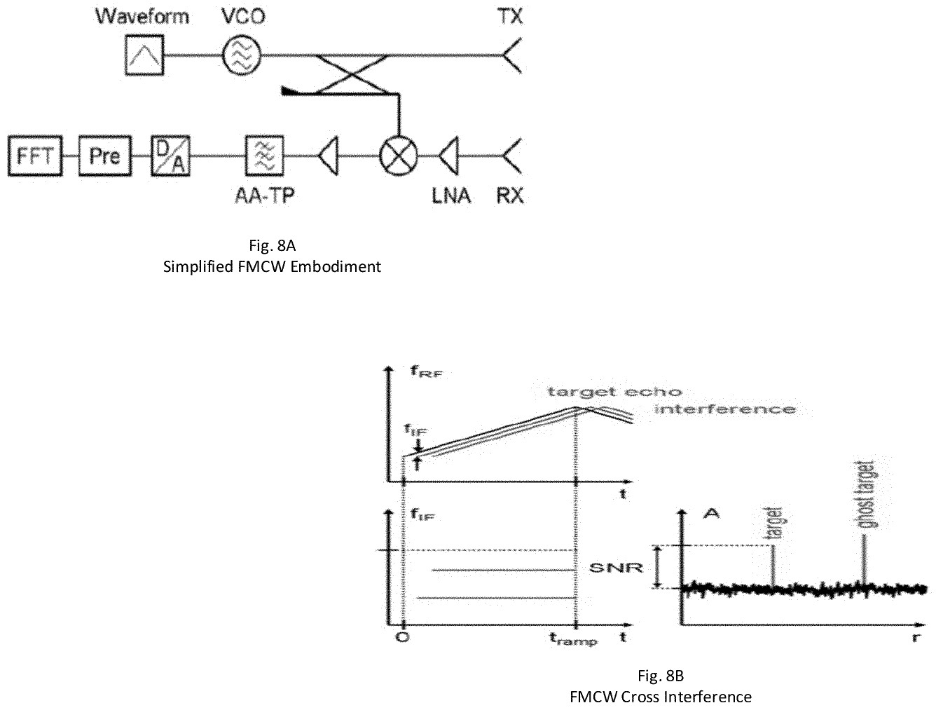

FIGS. 8A & 8B illustrate an exemplary FMCW radar and the (cross) interference which the radar may experience from signals originating from of FMCW radars. FIG. 8A is a simplified block diagram while FIG. 8B includes signal graphs illustrating the aforementioned interference.

In the block diagram of FMCW FIG. 8A, a chirp signal is modulated by the VCO. The transmitted signal frequency is modulated up and down. The received signal lags in time, according to the distance from the radar to the target. Multiplying the transmitted signal by the received signal generated DC signal, which is relative to the distance. The up-down modulation enables differentiating the range and the Doppler shift. FMCW radar, operating in the frequency band, generates a “ghost” echo, which must be identified and omitted. The interference mechanism is different in case the interference is different, in case of FMCW signal that is modulated with different slope than the interfered signal. Same phenomenon happens with OFDM radar interference.

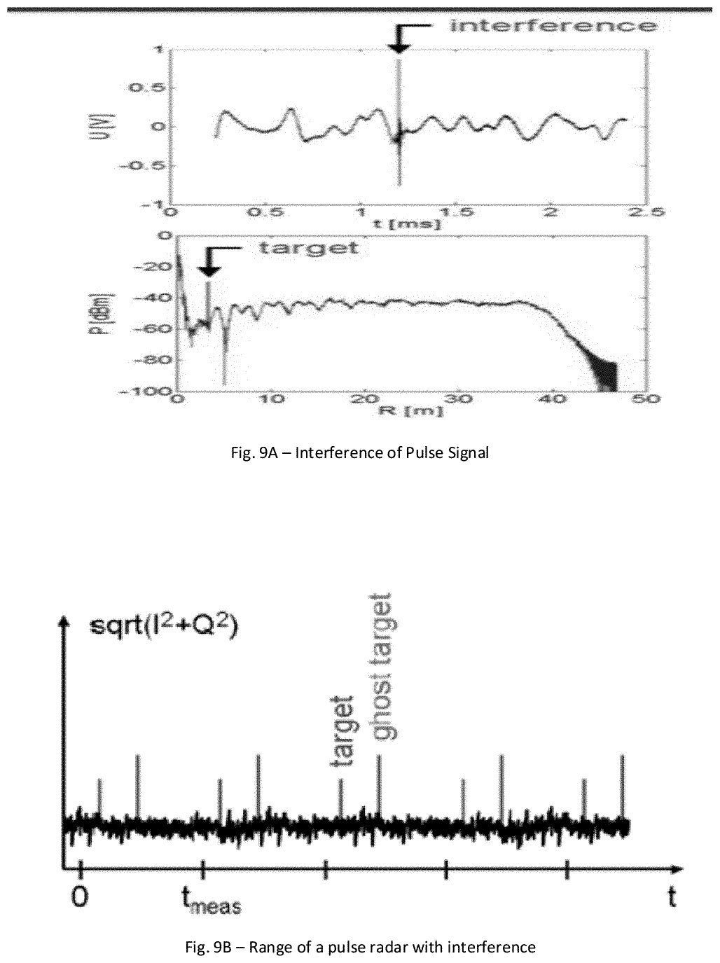

FIGS. 9A & 9B are signal graphs illustrating issues related with interference in pulsed radar systems. The specifics of that interference mechanism may be found the provisional application incorporated herein by reference in its entirety.

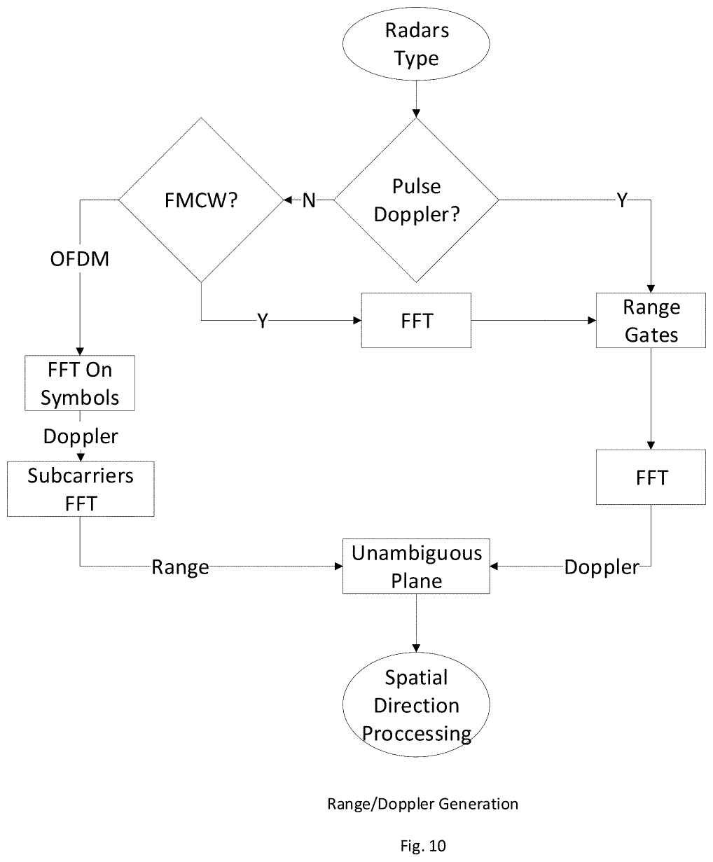

FIG. 10 relates to a method of spatial direction processing associated with cleaning ghosts from ranging and doppler-shift measurement associated with an object being detected in accordance with embodiments of the present invention. Independent of the radar type, processing the echoes results in unambiguous plane, for each receiving antenna. The spatial direction is calculated thereafter. Since each radar type, uses some method of orthogonality, the interference of different type of radar results in spread of interfering radar energy all over the unambiguous plane. As we see in FIG. 10 range/Doppler is generated independently of the radar type. If the same type of radar is interfering, the result will be appearances of “ghosts”—unreal targets that are generated by reflections of the interfering radar and directly by the interfering radar waveform. Ghosts are generated by a neighboring same type of radar direct radiation. The energy could be picked up through back lobe and side lobes. Embodiments of the present invention “cleans up” the unambiguous plan from those interferences.

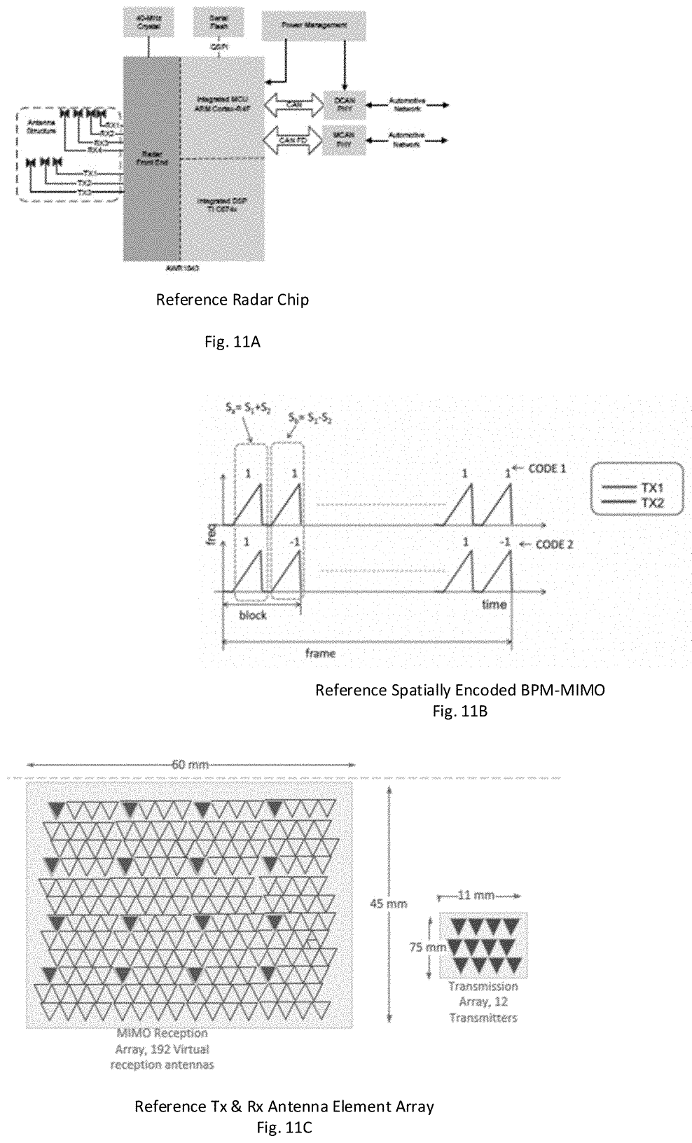

FIG. 11A to 11C illustrate an exemplary radar chip (FIG. 11A), and exemplary spatially encoded BPM-MIMO output waveform of the chip (FIG. 11B), and antenna arrays (Tx and Rx) corresponding to the chip and its Tx & Rx signal paths. More detail may be found in the provisional application incorporated by reference.

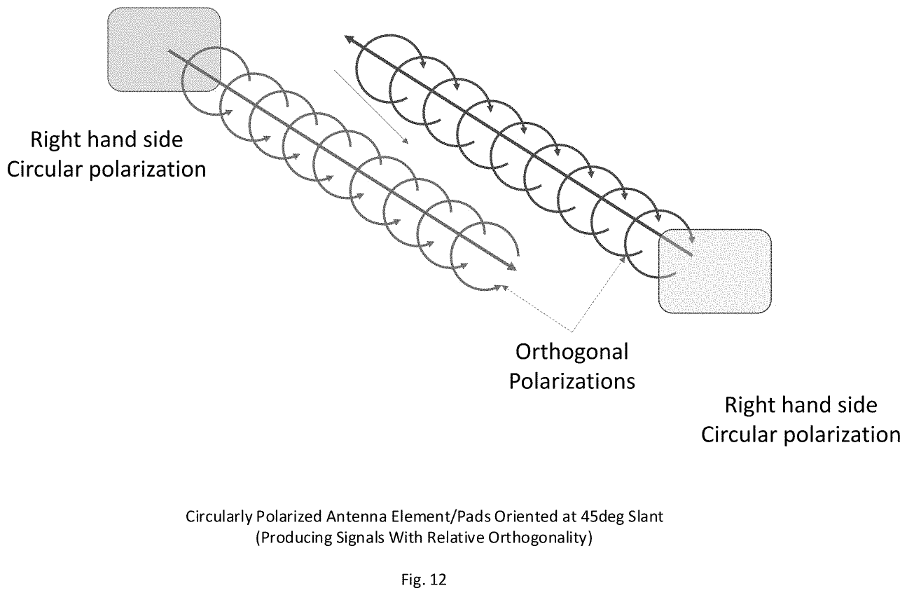

FIG. 12. Illustrates how circular polarization can be used to obtain signal orthogonality/isolation between a transmission from a transmitted antenna in a direction of a receiver antenna facing the transmitting antenna. This is applicable to mitigate interference signals coming from the opposite side of the road. The power generated by radars coming from the opposite side of the road will cause saturation the all radars in this side of the road. The reception power drops according to r⁻², compared to regular reflections that drop according to r⁻⁴.

The ratio between the strongest possible signal (car in the opposite side of the road) to the weakest signal (250 m ahead) is:

$$\frac{{P}_{strong}}{{P}_{weak}} = \frac{{P}_{T} \cdot {G}_{t} \cdot {G}_{r} \cdot {λ}^{2}}{{( 4 π )}^{2} \cdot {r}_{min}^{2}} \text{/} \frac{{P}_{T} \cdot {G}_{t} \cdot {G}_{r} \cdot {λ}^{2} \cdot σ}{{( 4 π )}^{3} \cdot {r}_{max}^{4}} = \frac{4 π \cdot {r}_{max}^{4}}{σ \cdot {r}_{min}^{2}}$$

### In dB

$$AGC = \frac{{P}_{strong}}{{P}_{weak}} = 11 + 96 + 5 - 0 - 20 = 92 dB$$

Assuming RCS of 1 sqrm, and calculation is done per single reception. The result is a need for applying AGC (reference design has 24 dB AGC), but it reduces sensitivity. There are 2 methods for mitigating this interference:
1. Use slant 45 or circular polarity. The polarity becomes orthogonal in opposite directions. The practical isolation is less than 30 dB, due to inaccuracy in generating cross polarization, cars exact direction etc. Generation of both circular and slant 45° polarization, with simple antenna elements such as patch or slot, is implemented by spatial summation of 2 optional elements, either with same phase (slant 45°) or with π/4 difference.
2. Simple spectral separation. In mobile phones, reception and transmission use separate spectrum. In radars, we offer to separate the transmissions per driving direction. For example: North-West direction uses lower band and East-South uses higher band or 1 GHz of the available 4 will be allocated to driving direction (N, W, S or E). The GPS computes the diving direction.

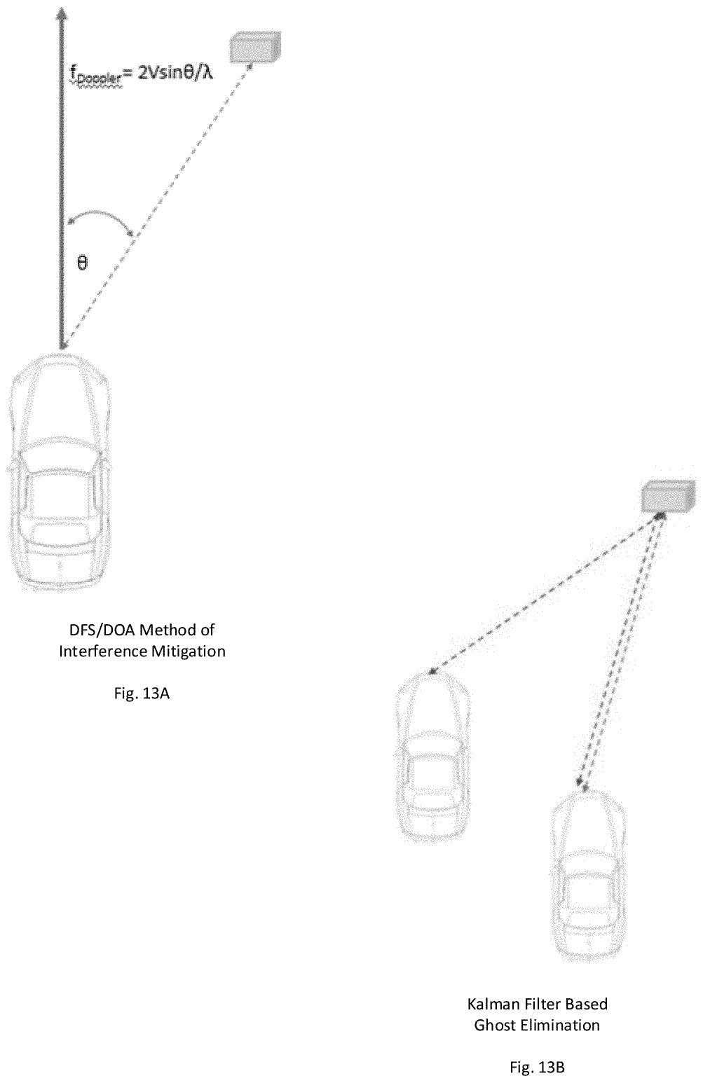

FIGS. 13A and 13B illustrate two separate computational methods of mitigating Ghost interference, possibly from nearby interference sources. The term “Ghosts Images” in radars refers to the appearance of targets on radar screen that have not been generated from radar beams reflections, or irrelevant targets.

In the Radar—INS system, there are several potential situations that could generate ghosts:
1. Targets reflections that produce no threat. Using the INS and road map eliminate the detect ghost
2. Ghosts are easily detected by shutting down the radar for a short period.

The DFS/DOA method is explained below with reference to FIG. 13A:
1. The radar on car is moving forward at speed of V, obtained from the INS.
2. The radar measures both the Doppler shift and the DOA (direction) to the possible target.
3. The accurate measurement of both the direction (θ) and the Doppler shift f_{Doppler} must comply with the equation:

$${f}_{Doppler} = \frac{2 \cdot v \cdot sin θ}{λ} .$$

If it does not comply, its a ghost,

Time Binary Sequence Algorithm for mitigating ghosts is applicable to the active sensor controller or sensor output according to embodiments of the present invention. Binary Phase modulation is a necessity for generation the transmission orthogonality in the MIMO process. The main features relevant to interference mitigation:
1. Orthogonality. Their cross correlation is ±1, where their summation reaches 1000, over 60 dB in power. It allows differentiating between the transmitters in the AESA array.
2. Interferences that are other types of radars are expanded all over the spectrum, which increases noise but does not generate false alarms.
3. The number of the series is half of their length

The number of available series in limited and obviously, cannot support all radars.

Orthogonality process: if ghosts flood the radar, select new set of orthogonal sequences. The selection will be done from a hash table. The index will generate by a function consisting of unique radar code and TOD from the INS (GPS).

Kalman Filter Approach: Target reflections generated by cars in opposite lane or by cars moving in the same lane. According to embodiments of the present invention, the radar absolute velocity, obtained by the INS, combined with measured range and measured Doppler shift, will detect that the reflections are generated not by the radar transmission. The radar controller builds a Kalman filter for each reflection and ignores reflections that the Kalman filter prediction does not agree with the measured position.

Functions, operations, components and/or features described herein with reference to one or more embodiments, may be combined or otherwise utilized with one or more other functions, operations, components and/or features described herein with reference to one or more other embodiments, or vice versa. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An obstacle detection system for a host vehicle, said system comprising:
a vehicle navigation system comprising: (a) a vehicle trajectory detector, (b) a geolocator circuit, and (c) a clock output;
an energy emitting type sensor (“active sensor”) to transmit energy (Tx Signal) towards a direction in a field of view of said active sensor and to receives a Tx Signal reflection (Rx Signal) reflected off of objects present within the field of view, wherein the field of view is directed towards a front of the host vehicle and said active sensor is digitally configurable to operate according to at least two different operating regimes; and
an active sensor controller configured to select an operating regime for said digitally configurable active sensor based on a ruleset which factors one or more navigation system outputs provided by said vehicle navigation system.

2. The system according to claim 1, wherein said active sensor is of a sensor type selected from the group consisting of: (1) Radar, (2) Lidar and (3) Sonar.

3. The system according to claim 1, wherein the ruleset of said active sensor controller factors one or more navigation system outputs selected from the ground consisting of: (a) present time; (b) host vehicle location; and (c) host vehicle trajectory.

4. The system according to claim 3, wherein said active sensor controller is configured to adjusts a characteristic of the Tx Signal of said active sensor based on the one or more navigation system outputs.

5. The system according to claim 4, wherein the adjustable characteristic of the Tx Signal is selected from group consisting of: (1) transmission modulation or coding regime of the Tx Signal, (2) a transmission direction or scanning pattern of the Tx Signal, (3) transmission timing (“TDM”) of the Tx Signal, and (4) transmission polarization of the Tx Signal.

6. The system according to claim 5, wherein said active sensor controller is configured to adjusting Rx Signal receiver circuit operation of said active sensor corresponding to any Tx Signal adjustments.

7. The system according to claim 1, wherein said active sensor is a multi-modulation radar and said active sensor controller causes the radar to switch between two or more operating standards selected from the group consisting of: (1) Frequency Modulated Constant Wave (FMCW), (2) Orthogonal Frequency Division Multiplexing (OFDM), and (3) Pulse Doppler, and Step Frequency or Frequency Hopping (SF/FH).

8. The system according to claim 1, further comprising an active sensor output processor functionally associated with said active sensor and adapted to process active sensor output signals from said active sensor at least partially based on a ruleset which factors one or more system outputs provided by said vehicle navigation system.

9. The system according to claim 8, wherein the ruleset of said active sensor output processor factors one or more navigation system outputs selected from the ground consisting of: (a) present time; (b) host vehicle location; and (c) host vehicle trajectory.

10. The system according to claim 9, wherein processing of active sensor output signals includes detecting an alert condition, maneuvering the host vehicle and/or stopping the host vehicle.

11. The system according to claim 10, wherein said navigation system is functionally associated with a digital road map and wherein active sensor output processing includes detecting obstacles around a host vehicle and estimating a position of the obstacle within a reference frame defined by the road map.

12. The system according to claim 11, wherein active sensor output processing further includes estimating a velocity vector and trajectory of the obstacle within the reference frame defined by the road map.

13. The system according to claim 12, wherein active sensor output processor is further adapted to generate an alert notification if the estimated trajectory of the detected obstacle and the trajectory of the host vehicle intersect.

14. The system according to claim 1, wherein said active sensor is adapted to transmit and receive electromagnetic signals within each of two or more frequency bands and said controller is adapted to select in which band the active sensor is operating based on information provided by said navigation system.

15. The system according to claim 14, wherein said active sensor is adapted to operate within different frequency bands at different angles relative to a host vehicle.

16. The system according to claim 15, wherein said controller configures said active sensor to operate in a first frequency band at angles towards the left side of a host vehicle and to operate in a second frequency band at angles towards the right side of a host vehicle.

17. The system according to claim 16, wherein said controller configures said radar to swap or otherwise alternate directions of the first and second bands of operation, such that the first band is used to operate towards the right side of a host vehicle and the second band is used to operate towards the left side of a host vehicle.

18. The system according to claim 16, wherein said controller configures said radar to adjust the frequencies of each of the first and second bands of operation.

19. The system according to claim 8, wherein said active sensor output processor is further adapted to distinguish between a received (Rx) signal which originated as a Transmission (Tx) from by said active sensor and a received signal which originated from an interfering signal source.

20. The system according to claim 8, wherein said active sensor output processor or said active sensor controller are configured to mitigate interference to the operation of said active sensor from external signal sources.
